(19) United States
(12) Patent Application Publication
(10) Pub. No.: US 2014/0002325 A1
(43) Pub. Date: Jan. 2, 2014

(54) ELECTRODE MEMBER, ANTENNA CIRCUIT AND IC INLET

(71) Applicant: Taiga Matsushita, Tokyo (JP)

(72) Inventor: Taiga Matsushita, Tokyo (JP)

(73) Assignee: LINTEC CORPORATION, Tokyo (JP)

(21) Appl. No.: 14/003,993

(22) PCT Filed: Mar. 16, 2012
(86) PCT No.: PCT/JP2012/056836

§ 371 Date: Sep. 9, 2013

(30) Foreign Application Priority Data
Mar. 22, 2011 (JP) 2011-063007

(51) Int. Cl. H01Q 1/38; H01Q 7/00

(52) U.S. Cl. CPC H01Q 1/38; H01Q 7/00
USPC 343/870

(57) ABSTRACT

An electrode member includes: a circuit substrate; and a first terminal and a second terminal being provided on at least one surface of the circuit substrate and being not electrically conductive with each other. The first terminal and the second terminal are brought into electrical conduction through a jumper. At least one of the first terminal and the second terminal is provided with a non-linear portion formed in a periphery thereof at a position overlapping with the jumper, the non-linear portion being in a non-linear shape in a plan view of the circuit substrate.

### TECHNICAL FIELD

The present invention relates to an electrode member, an antenna circuit and an IC inlet.

### BACKGROUND ART

There is typically known a non-contact RFID (Radio Frequency Identification) in which an IC tag is attached to an article such as a book for identifying or controlling the article (see, for instance, Patent Literature 1).

As shown in FIG. 11, Patent Literature 1 describes an arrangement including a circuit substrate 3, an antenna circuit 9 provided on a surface of the circuit substrate 3, and an IC chip (not shown). The antenna circuit 9 includes a circuit pattern 40, a first terminal 91, a second terminal 92, a third terminal (not shown), an insulating film 44 and a jumper 45.

The circuit pattern 40 is coiled along a periphery of the circuit substrate 3 that is formed in a rectangular plate-like shape (not shown in FIG. 11).

The first terminal 91 is electrically conductive with an inner end of the circuit pattern 40. The second terminal 92 is opposed to the first terminal 91 across the circuit pattern 40. A side edge 911 of the first terminal 91 and a side edge 921 of the second terminal 92, which are opposed to the circuit pattern 40, are each in a linear shape in a plan view of the circuit substrate 3.

The third terminal is electrically conductive with an outer end of the circuit pattern 40.

An IC chip is provided between the second terminal 92 and the third terminal. The IC chip is electrically conductive with the second terminal 92 and the third terminal thorough two lead wires, respectively.

The insulating film 44 is provided to cover a portion of the circuit pattern 40 between the first terminal 91 and the second terminal 92.

The jumper 45 includes a first connecting portion 451 being provided on the first terminal 91, a second connecting portion 452 being provided on the second terminal 92, and an interconnect portion 453 being provided on the insulating film 44 to connect the first connecting portion 451 and the second connecting portion 452 to each other. In other words, the jumper 45 is provided to bring the first terminal 91 and the second terminal 92 into electrical conduction while being not electrically conductive with the circuit pattern 40 through the insulating film 44. An electrically-conductive paste may be printed for forming the jumper 45 in terms of cost and process.

### CITATION LIST

### Patent Literature(s)

Patent Literature 1: JP-A-2010-20472

### SUMMARY OF THE INVENTION

### Problems to be Solved by the Invention

The IC tag as described in Patent Literature 1 is required to have flex resistance because the IC tag is occasionally attached to a book or put in a purse. However, the arrangement as described in Patent Literature 1 is likely to entail the following problems when the circuit substrate 3 is bent around a linear bending line L, which substantially coincides with the side edge 911, with an excessive bending force into such a mountain-like shape as the bending line L is seen as a ridge.

As shown in FIG. 12, a portion 954 at which the jumper 45 is bent along the bending line L (hereinafter referred to as a jumper-bent portion 954 (shown by a two-dot chain line)) is subject to a force that causes a crack depending on the bending of the jumper-bent portion 954. In particular, the jumper-bent portion 954 has a portion overlapping with the side edge 911 (hereinafter referred to as an overlap portion) and the existence of the side edge 911 results in a step bounded by the overlap portion. As a result, the overlap portion is lifted toward the ridge of the mountain shape because of the side edge 911 and the lifting force acts on the jumper-bent portion 954 as a force for causing a crack (hereinafter referred to as a crack-causing force).

In the arrangement shown in FIG. 12, since the jumper-bent portion 954 entirely coincides with the linear side edge 911, the juniper-bent portion 954 is provided only by the overlap portion. As a result, when the entirety of the jumper-bent portion 954 suffers from the crack-causing force applied from the step and the circuit substrate 3 is repeatedly bent around the bending line L, it is likely that the jumper 45 is completely torn or broken as shown in FIG. 13 and thus the first terminal 91 and the second terminal 92 cannot be electrically conductive.

An object of the invention is to provide an electrode member, an antenna circuit and an IC inlet in which breakage of an electrically-conductive member through which a first terminal and a second terminal are electrically conductive can be inhibited.

### Means for Solving the Problems

According to an aspect of the invention, the following arrangements are provided.

(1) According to an aspect of the invention, an electrode member includes: a circuit substrate; and a first terminal and a second terminal being provided on at least one surface of the circuit substrate and being not electrically conductive with each other, the first terminal and the second terminal being brought into electrical conduction through an electrically-conductive member, in which at least one of the first terminal and the second terminal is provided with a non-linear portion formed in a periphery thereof at a position overlapping with the electrically-conductive member, the non-linear portion being in a non-linear shape in a plan view of the circuit substrate.

(2) In the above aspect, it is preferable that the non-linear portion includes at least one of a bent portion being bent at an acute angle or an obtuse angle, a bent portion in a corrugated shape, and a bent portion in a substantially square C-shape.

(3) According to another aspect of the invention, an antenna circuit includes: the electrode member; a coiled circuit pattern being provided on the one surface of the circuit substrate on which the first terminal and the second terminal are provided; and an electrically-conductive member through which the first terminal and the second terminal are brought into electrical conduction.

(4) According to still another aspect of the invention, an IC inlet includes: the antenna circuit; and an IC chip, in which the electrode member, the circuit pattern and the electrically-conductive member are brought into electrical conduction through the IC chip to form a loop.

In the electrode member, the antenna circuit and the IC inlet according to the above aspects, it is possible to inhibit breakage of the electrically-conductive member through which the first terminal and the second terminal are brought into electrical conduction.

### BRIEF DESCRIPTION OF DRAWINGS

FIG. 1 is a sectional view of an IC tag according to an exemplary embodiment of the invention.

FIG. 2 is a plan view showing an IC inlet of an IC tag according to the exemplary embodiment and Example 1.

FIG. 3 is a plan view showing a relevant part of the IC tag according to the exemplary embodiment.

FIG. 4 shows the IC tag according to the exemplary embodiment before being cracked for explaining an effect of the IC tag.

FIG. 5 shows the IC tag according to the exemplary embodiment after being cracked for explaining the effect of the IC tag.

FIG. 6 is a plan view showing a relevant part of an IC tag according to Example 2 of the exemplary embodiment.

FIG. 7 is a plan view showing a relevant part of an IC tag according to Example 3 of the exemplary embodiment.

FIG. 8 is a plan view showing a relevant part of an IC tag according to Example 4 of the exemplary embodiment.

FIG. 9 is a plan view showing a testing elongated sheet in relation to Examples of the exemplary embodiment.

FIG. 10 is an explanatory view of a bending test in relation to Examples.

FIG. 11 is a plan view showing a relevant part of an IC tag according to a typical arrangement of prior art and Comparative 1 of the exemplary embodiment.

FIG. 12 shows the IC tag according to the typical arrangement before being cracked for explaining an effect of the IC tag.

FIG. 13 shows the IC tag according to the typical arrangement after being cracked for explaining the effect of the IC tag.

### DESCRIPTION OF EMBODIMENT(S)

In an electrode member and an antenna circuit according to an exemplary embodiment, for instance, a non-linear portion, which is in a non-linear shape in a plan view of a circuit substrate, is formed in a side edge of a periphery of a first terminal at a position overlapping with a jumper (i.e., an electrically-conductive member).

With this arrangement, when the circuit substrate is bent around a linear bending line that partly coincides with the side edge into such a mountain-like shape as the bending line is seen as a ridge, a jumper-bent portion (a bent portion of the jumper) includes an overlap portion that is located on the non-linear portion of the side edge and a non-overlap portion that is not located on the non-linear portion.

Since a non-overlap portion of the jumper-bent portion does not coexist with the side edge, a step bounded by the non-overlap portion is not formed. As a result, even when the circuit substrate is bent, it is unlikely that the non-overlap portion is lifted toward the ridge because of the side edge to suffer from the crack-causing force.

Therefore, even when the circuit substrate is repeatedly bent, the non-overlap portion of the jumper-bent portion can be inhibited from being cracked while the overlap portion is easily cracked because of the influence of the crack-causing force. As a result, the jumper-bent portion is inhibited from being entirely broken.

In the electrode member according to the exemplary embodiment, it is preferable that the non-linear portion includes a bent portion that is bent at an acute or obtuse angle.

Alternatively, in the electrode member according to the exemplary embodiment, it is preferable that the non-linear portion includes a bent portion that is corrugated like a sine curve.

Further alternatively, in the electrode member according to the exemplary embodiment, it is preferable that the non-linear portion includes a bent portion in a substantially square C-shape.

An IC inlet according to the exemplary embodiment includes the antenna circuit and an IC chip. The electrode member, the circuit pattern and the electrically-conductive member are brought into electrical conduction through the IC chip to form a loop.

With this arrangement, it is possible to inhibit breakage of the jumper, i.e., the electrically-conductive member, to provide a flexible IC inlet with a high flex resistance.

### Embodiment

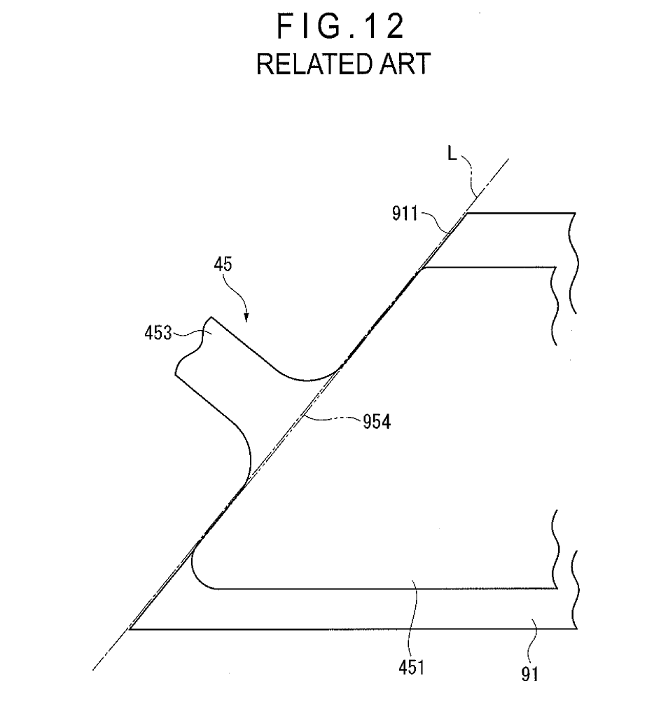

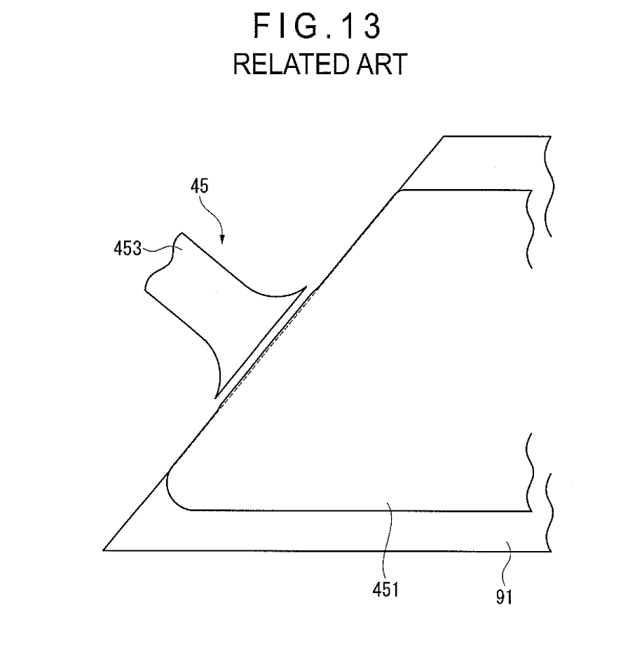

An exemplary embodiment of the invention will be described below with reference to the attached drawings. Incidentally, the same components as those of the typical arrangement described with reference to FIGS. 11 to 13 will be named the same and attached with the same reference numbers, thereby omitting or simplifying the explanation thereof.

### General Arrangement of IC Tag

First, a general arrangement of an IC tag will be described.

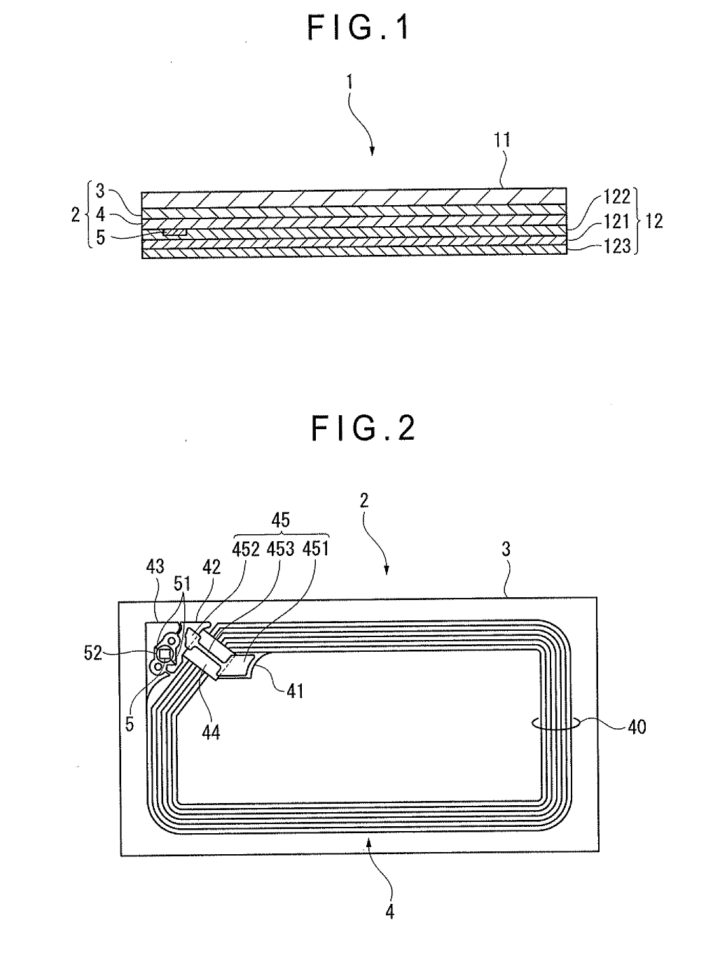

As shown in FIG. 1, an IC tag 1 according to the exemplary embodiment, which is a passive IC tag, is provided by forming an IC inlet 2 into a tag-like shape through a predetermined tag processing. The IC tag 1 includes the IC inlet 2, a printable front sheet 11 and a double-sided adhesive sheet 12.

The IC inlet 2 includes a circuit substrate 3 in a rectangular plate-like shape, an antenna circuit 4 and an IC chip 5.

The printable front sheet 11 is provided on a second surface opposite to a first surface of the circuit substrate 3 on which the antenna circuit 4 is formed. The printable front sheet 11 may be provided on the first surface of the circuit substrate 3 on which the antenna circuit 4 is formed.

The double-sided adhesive sheet 12 is provided on the first surface of the circuit substrate 3 on which the antenna circuit 4 is formed to protect the antenna circuit 4 and the IC chip 5. The double-sided adhesive sheet 12 includes a sheet-like protection layer 121, an adhesive layer 122 provided on a first surface of the protection layer 121, and an adhesive layer 123 provided on a second surface of the protection layer 121 opposite to the first surface. The adhesive layer 122, which serves to stick the protection layer 121 on the circuit substrate 3, follows the unevenness of the antenna circuit 4 and the mounted IC chip 5 to seal them. The adhesive layer 123 serves to attach the IC tag 1 to an article such as a book. The double-sided adhesive sheet 12 may be provided on the second surface opposite to the first surface of the circuit substrate 3 on which the antenna circuit 4 is formed.

As shown in FIG. 2, the antenna circuit 4 includes: a circuit pattern 40 being coiled along a periphery of the circuit substrate 3; a first terminal 41 being electrically conductive with an inner end of the circuit pattern 40; a second terminal 42 being opposite to the first terminal 41 across the circuit pattern 40; a third terminal 43 being electrically conductive with an outer end of the circuit pattern 40; an insulating film 44 that covers a portion interposed between the first terminal 41 and the second terminal 42 of the circuit pattern 40; and a jumper 45 that serves as an electrically-conductive member through which the first terminal 41 and the second terminal 42 are electrically conductive with each other.

The circuit substrate 3, the first terminal 41 and the second terminal 42 in combination define an electrode member according to the exemplary embodiment.

The circuit pattern 40 mainly serves as an antenna and a power supply. The circuit pattern 40 may be formed by any one of the following methods: coiling a metal wire of gold, silver, copper, nickel, aluminum, etc., a coated copper wire, or the like; printing an electrically-conductive paste (described below) in a coil-like shape; and forming an electrically-conductive metal layer of copper, gold, silver, nickel, aluminum, etc. laminated on the circuit substrate 3 into a coil-like shape through etching.

The first, second and third terminals 41, 42, 43 may be formed in the same manner as the circuit pattern 40.

For the insulating film 44, an insulating resin that consists mainly of an acrylic resin, an urethane resin or an acrylic urethane resin is usable.

The jumper 45 includes a first connecting portion 451 being at least partly provided on the first terminal 41, a second connecting portion 452 being at least partly provided on the second terminal 42, and an interconnect portion 453 being provided on the insulating film 44 to connect the first connecting portion 451 and the second connecting portion 452 to each other. In other words, the jumper 45 is not electrically conductive with the circuit pattern 40. The jumper 45 is provided by printing an electrically-conductive paste or an electrically conductive ink made of dispersed metal particles of gold, silver, copper, aluminum, nickel or the like.

The IC chip 5 is electrically conductive with the second terminal 42 and the third terminal 43 through two lead wires 51, respectively. Specifically, the IC chip 5 is flip-chip mounted using a bonding member 52. After the IC chip 5 is mounted, the bonding member 52 is cured through thermocompression to be located between the IC chip 5 and the circuit substrate 3 as well as on a periphery of the IC chip 5. As the bonding member 52, for instance, a solder, an anisotropic conductive adhesive (ACA) and an anisotropic conductive paste (ACP) are usable.

Incidentally, although the IC chip 5 is mounted outside the circuit pattern 40 according to the exemplary embodiment, the IC chip 5 may be mounted inside the circuit pattern 40 or on a plurality of coiled wires. For such an alternative arrangement, the positions and the numbers of the first, second and third terminals 41, 42, 43 need to be appropriately adjusted.

In this manner, free ends of the antenna circuit are connected to each other for electrical conduction through the IC chip, thereby providing the circuit of the IC inlet of the exemplary embodiment through which electric current circulates. It should be noted that such a circuit is called a loop.

### Arrangement of Relevant Part of IC Tag

Next, description will be made on an arrangement of a relevant part of the IC tag 1.

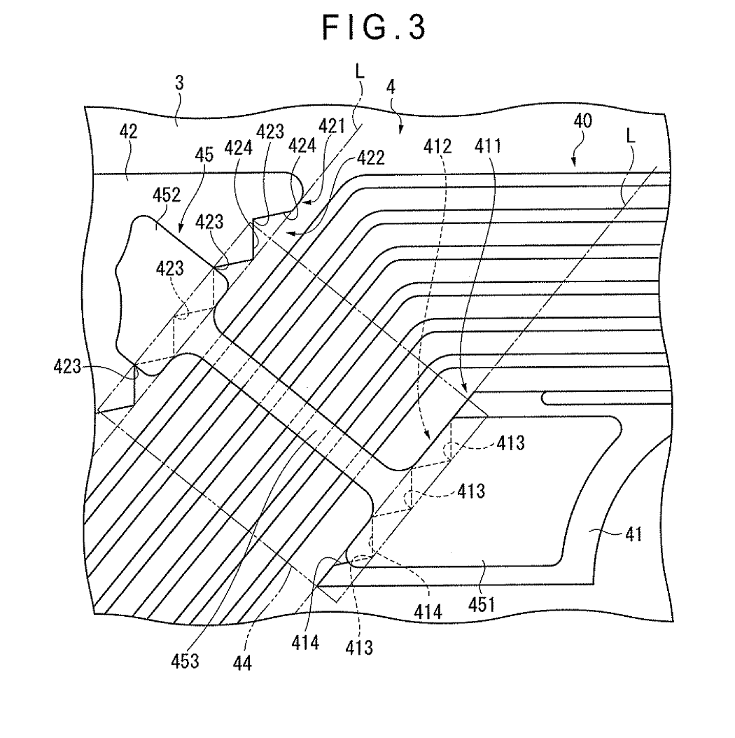

As shown in FIG. 3, a first side edge 411 of the first terminal 41 opposed to the circuit pattern 40 is provided with a non-linear portion 412 that is in a non-linear shape in a plan view of the circuit substrate 3. The non-linear portion 412, which is formed in a concavo-convex shape, includes a plurality of continuous bent portions 413 that are bent at an obtuse angle. Each of the bent portions 413 includes two linear sides 414.

An angle of the bent portions 413 is preferably in a range from 90 degrees to 170 degrees, more preferably from 90 degrees to 120 degrees. When the angle exceeds 170 degrees to approximate to 180 degrees, a breakage inhibitory effect on the jumper 45 (described later) is likely to be lowered.

A height of the bent portions 413 (a recess depth) is preferably in a range from 0.01 mm to 5 mm, more preferably from 0.1 mm to 2 mm. One pitch of the bent portions 413 (a distance between adjacent ones of the bent portions 413) is preferably in a range from 0.01 mm to 5 mm, more preferably from 0.1 mm to 2 mm. When the height and the pitch are shorter than 0.1 mm, the bent portions 413 become too fine to form with accuracy, so that the breakage inhibitory effect on the jumper 45 is likely to be lowered. On the other hand, when the height or the pitch exceed 5 mm, the bent portions 413 become so large that the breakage inhibitory effect on the jumper 45 is also likely to be lowered.

The non-linear portion 412 is superposed on the first connecting portion 451 of the jumper 45. In other words, a portion of the first terminal 41 superposed on the jumper 45 is not in a linear shape but in a concavo-convex shape.

A side edge 421 of the second terminal 42 opposed to the circuit pattern 40 is likewise provided with a non-linear portion 422 in the same shape as the non-linear portion 412. The non-linear portion 422 includes a plurality of bent portions 423 that are bent at an obtuse angle and each include two linear sides 424. The non-linear portion 422 is superposed on the second connecting portion 452 of the jumper 45. In other words, a portion of the second terminal 42 superposed on the jumper 45 is not in a linear shape but in a concavo-convex shape.

### Effect of IC Tag

Next, description will be made on an effect of the IC tag 1 arranged as described above.

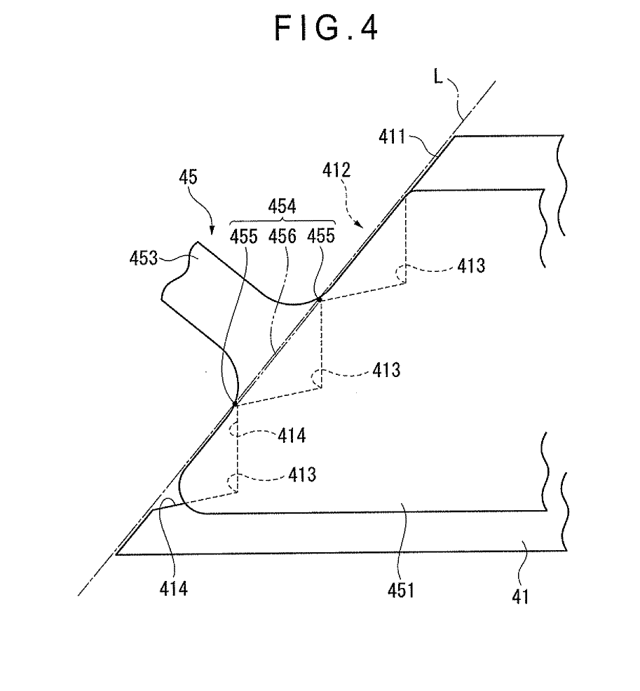

As shown in FIGS. 3 and 4, when the IC tag 1 is bent into a mountain-like shape around a linear bending line L that substantially coincides with the side edge 411 of the first terminal 41, a force acts on the antenna circuit 4 as described below.

As shown in FIG. 4, a jumper-bent portion 454 (a bent portion of the jumper 45 (shown by a two-dot chain line)) includes an overlap portion 455 that is superposed on the non-linear portion 412 and a non-overlap portion 456 that is not superposed on the side edge 411 and the non-linear portion 412.

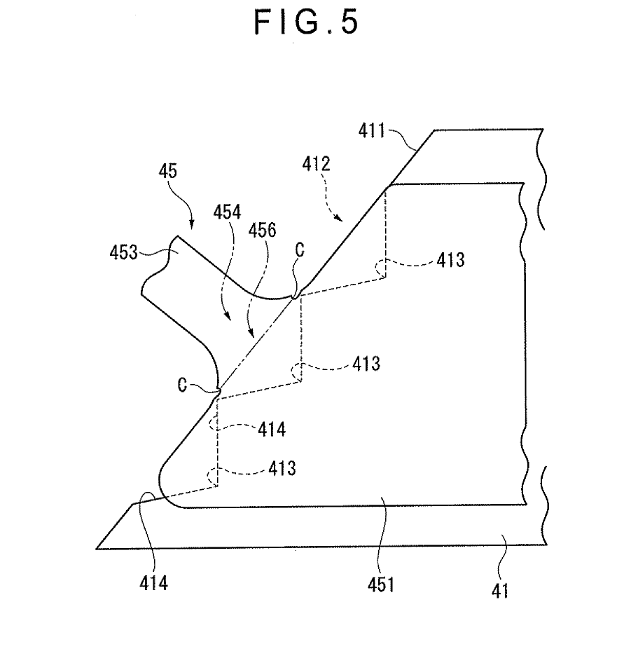

With this arrangement, when the circuit substrate 3 is bent, while the overlap portion 455 is subject to a crack-causing force resulting from a step bounded by the overlap portion 455, the non-overlap portion 456 is not subject to such a crack-causing force. Therefore, even when the circuit substrate 3 is repeatedly bent, a crack C is likely to be caused at the overlap portion 455 but not at the non-overlap portion 456 as shown in FIG. 5, so that entire breakage of the jumper-bent portion 454 can be inhibited.

Even when the IC tag 1 is bent into a mountain-like shape around a linear bending line that substantially coincides with the side edge 421 of the second terminal 42, the jumper-bent portion is inhibited from being entirely broken due to the existence of the non-linear portion 422 with the above effect. Likewise, even when the IC tag 1 is bent into a valley-like shape, the breakage inhibitory effect can be provided to inhibit entire breakage of the jumper-bent portion.

### Advantages of Exemplary Embodiment

The IC tag 1 according to the exemplary embodiment includes the non-linear portions 412, 422 provided in the side edges 411, 421 of the first and second terminals 41, 42. With this arrangement, when the circuit substrate 3 is bent, while the overlap portion 455 of the jumper-bent portion 454 is subject to the crack-causing force, the non-overlap portion 456 of the jumper-bent portion 454 is not subject to the crack-causing force. As a result, even when the circuit substrate 3 is repeatedly bent, it is possible to inhibit entire breakage of the jumper-bent portion 454.

Moreover, when the angle of the bent portions 413, 423 is set at 170 degrees or smaller and the height and the pitch of the bent portions 413, 423 are set in a range from 0.01 mm to 5 mm, the breakage inhibitory effect on the jumper 45 can be enhanced.

### Modifications of Exemplary Embodiment

It should be noted that the invention is not limited to the exemplary embodiment but may include the following modifications.

Although the IC tag is exemplarily usable for a non-contact RFID in the exemplary embodiment, the IC tag may be usable for an RFID module. Additionally, the IC tag may also be usable for a non-contact IC card or an IC card module.

Although the IC tag is exemplarily a passive one in the exemplary embodiment, it may be an active IC tag.

It is not requisite to provide both the non-linear portion 412 and the non-linear portion 422 and thus either one of them may be provided.

It is not requisite for the non-linear portions 412, 422 to include the plurality of bent portions 413, 423. The non-linear portion 412 may include a single bent portion 413 and the non-linear portion 422 may include a single bent portion 423.

The bent portions may be bent not at an obtuse angle but at an acute angle. The acute angle may be in a range from 10 degrees to 90 degrees, more preferably from 30 degrees to 90 degrees. With an angle smaller than 10 degrees, the distance between adjacent ones of the bent portions becomes extremely narrow, so that the breakage inhibitory effect on the jumper 45 is likely to be lowered.

The non-linear portion may be formed in any non-linear shape. For instance, the non-linear portion may include at least one bent portion in a corrugated shape like a sine curve etc. or in a substantially square C-shape.

When the bent portion is in the shape with an acute angle, the corrugated shape or the substantially square C-shape as described above, the height and the pitch of the bent portions are preferably in a range from 0.01 mm to 5 mm, more preferably from 0.1 mm to 2 mm. With the above arrangement, the bent portions can provide the same effect as the bent portions 413, 423 of the exemplar embodiment to enhance the breakage inhibitory effect on the jumper 45.

### EXAMPLES

The exemplary embodiment will be described in further detail with reference to Examples, which by no means limit the exemplary embodiment.

### Example 1

An IC tag according to Example 1 was manufactured by carrying out a manufacturing process of an antenna circuit, a manufacturing process of an IC inlet and a manufacturing process of an IC tag.

### Manufacturing Process of Antenna Circuit

As shown in FIG. 3, an etching resist pattern was screen-printed on a polyethylene terephthalate (PET) film (i.e., the circuit substrate 3) stuck with a copper foil, i.e., NIKAFLEX (manufactured by NIKKAN INDUSTRIES CO., LTD. (copper/PET-35 μm/50 μm), product name: F-10T50C-1). Subsequently, an unneeded part of the copper foil was removed by etching, thereby forming the circuit pattern 40 and the first, second and third terminals 41, 42, 43 on the PET film. Subsequently, for bringing the first terminal 41 and the second terminal 42 into electrical conduction, the rectangular insulating film 44 of 25 μm thickness was formed of an insulating resist ink (manufactured by TOYOBO CO., LTD., product name: RF-100G-35) on the circuit pattern 40 between the first terminal 41 and the second terminal 42 as shown in FIG. 3, and then the jumper 45, which includes the first connecting portion 451, the second connecting portion 452 and the interconnect portion 453, was formed of a silver paste material (manufactured by TOYOBO CO., LTD., product name: DW250L-1) as shown in FIG. 3 to bring the first terminal 41 and the second terminal 42 into electrical conduction. The jumper 45 was formed by screen printing. The antenna circuit 4 was manufactured in the above manner.

The side edges 411, 421 of the first and second terminal 41, 42 include the non-linear portions 412, 422 in a concavo-convex shape that include the plurality of bent portions 413, 423 bent at an obtuse angle as shown in FIG. 3. The angle of the bent portions 413, 423 was 100 degrees and the length of each of the sides 414, 424 of the bent portions 413, 423 was 0.64 mm.

### Manufacturing Process of IC Inlet

An RFID-IC chip 5 (manufactured by NXP Semiconductors, product name: ICODESLD was flip-chip mounted on the antenna circuit 4 for manufacturing an IC inlet. A flip-chip mounter (manufactured by Kyushu Matsushita Electric Co., Ltd., product name: FB30T-M) was used for the mounting. An anisotropic conductive paste (ACP) (manufactured by KYOCERA Chemical Corporation, product name: TAP0602F) was used as the bonding member 52. The mounting was carried out under the following conditions: a heating temperature of the ACP on the IC chip 5: 220 degrees C.; a load on the IC chip 5: 2 N (200 gf); and a heating and compressing time: seven seconds.

### Manufacturing Process of IC Tag

For manufacturing an IC tag, the surface of the IC inlet on which the IC chip 5 was mounted was stuck with the double-sided adhesive sheet (manufactured by LINTEC Corporation, product name: PET25W PAT1 8KX 8EC) and the opposite surface of the IC inlet was stuck with a polyethylene terephthalate film (i.e., the printable front sheet) (manufactured by TOYOBO CO., LTD., product name: CRISPER K2411).

20 IC tags were manufactured in the above manner. Regarding an outline of the IC tags, a length of a long side was 65 mm and a length of a short side was 35 mm.

### Example 2

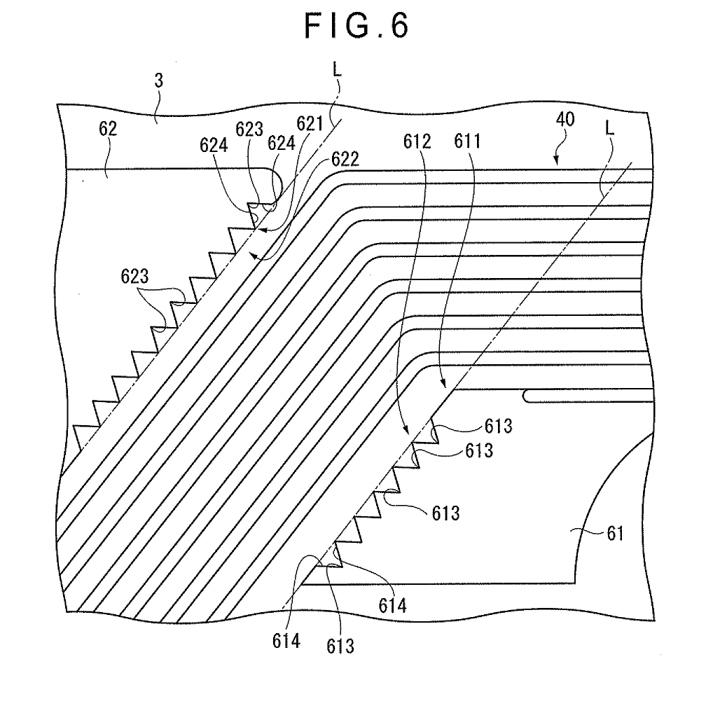

As shown in FIG. 6, 20 IC tags were manufactured in Example 2 under the same conditions as in Example 1 except that side edges 611, 621 of first and second terminals 61, 62 were provided with non-linear portions 612, 622 in a concavo-convex shape that included a plurality of bent portions 613, 623 bent at an acute angle. An angle of the bent portions 613, 623 was 65 degrees. Sides 614,624 of the bent portions 613, 623 each had a length of 0.5 mm.

### Example 3

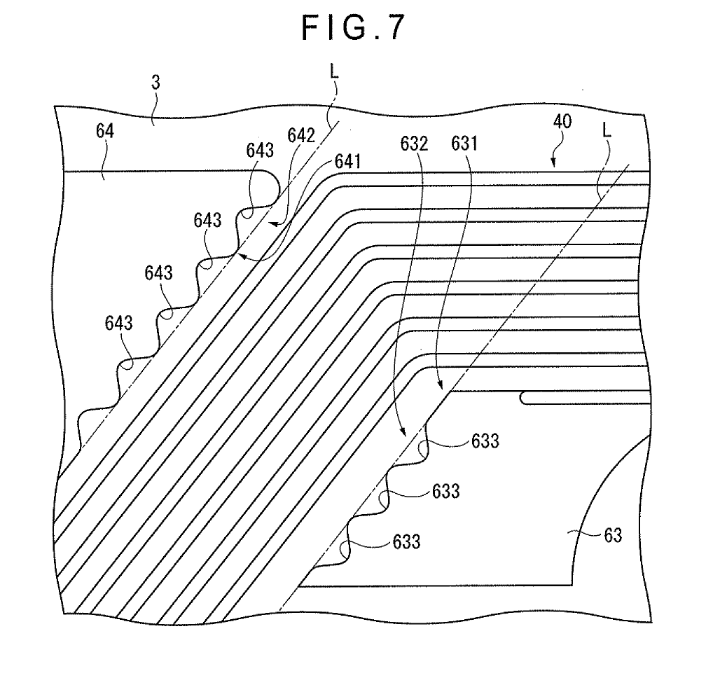

As shown in FIG. 7, 20 IC tags were manufactured in Example 3 under the same conditions as in Example 1 except that side edges 631, 641 of first and second terminals 63, 64 were provided with non-linear portions 632, 642 in a concavo-convex shape that included a plurality of bent portions 633, 643 bent in a corrugated shape like a sine curve. Specifically, the bent portions 633, 643 were formed in a corrugated shape like a sine curve with 1.2 mm pitch and 0.6 mm height.

### Example 4

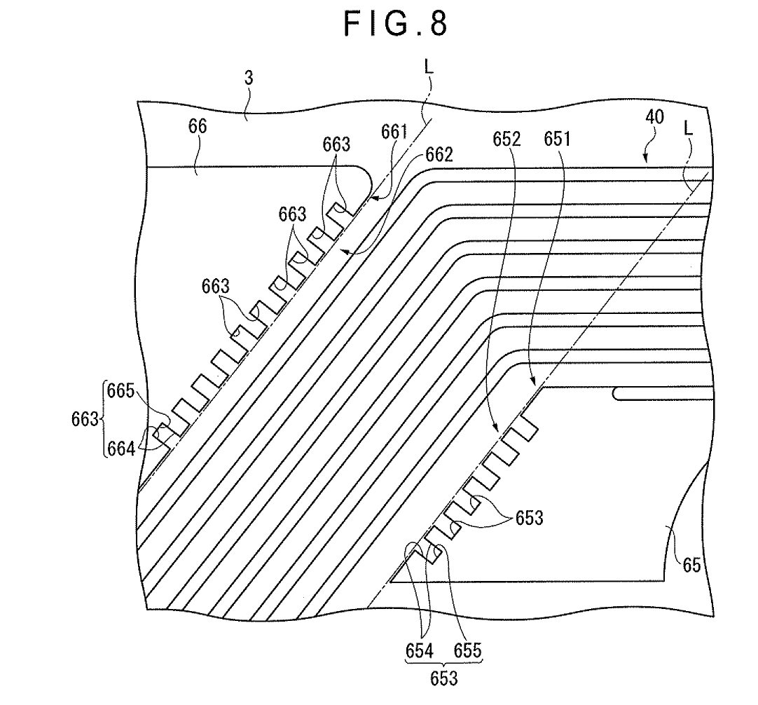

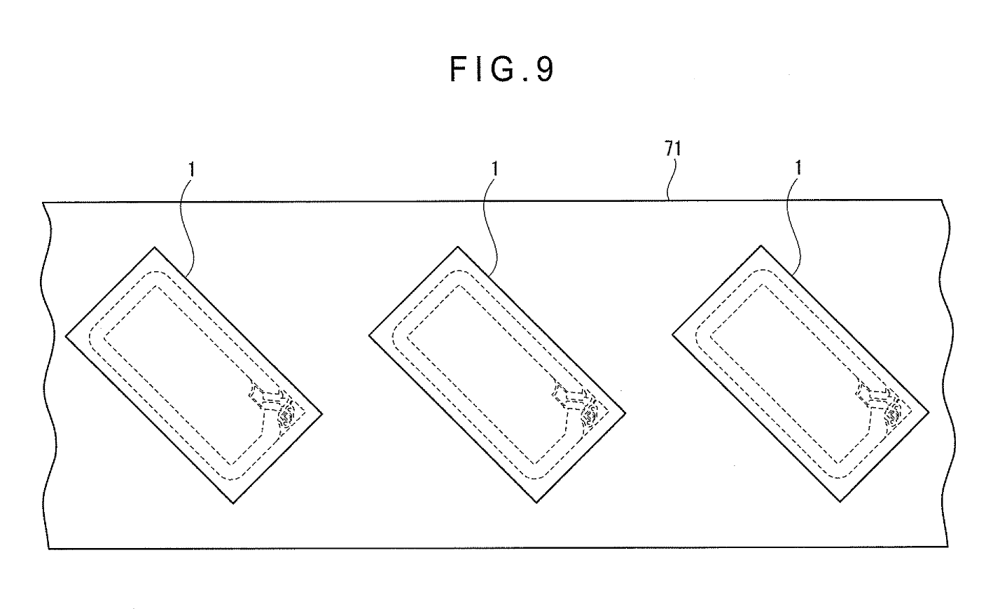

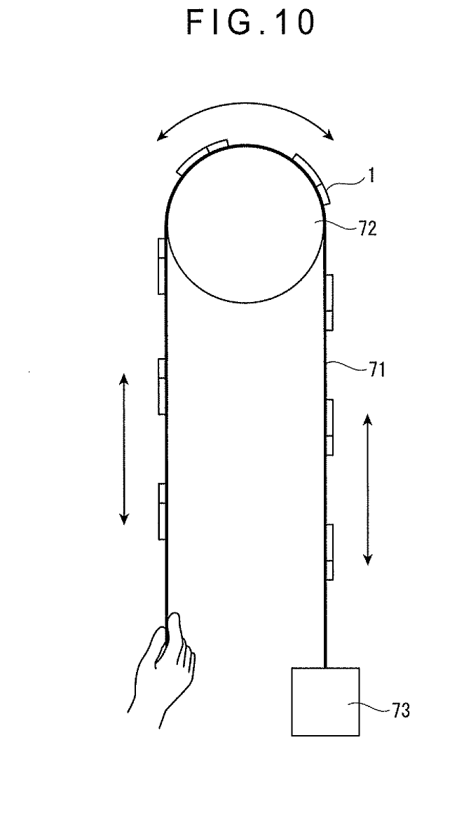

As shown in FIG. 8, 20 IC tags were manufactured in Example 4 under the same conditions as in Example 1 except that side edges 651, 661 of first and second terminals 65, 66 were provided with non-linear portions 652, 662 in a concavo-convex shape that included a plurality of bent portions 653, 663 bent in a substantially square C-shape (a rectangular shape). The bent portions 653, 663 included sides 654, 664 defined in a depth direction thereof and sides 655, 665 defined in a width direction thereof. A length of each of the sides 654, 664 was 0.4 mm and a length of each of the sides 655, 665 was 0.25 mm.

### Comparative 1

As shown in FIG. 11, 20 IC tags were manufactured in Comparative 1 under the same conditions as in Example 1 except that side edges 911, 921 of the first and second terminals 91, 92 were linearly formed, i.e., the side edges 911, 921 were not provided with a non-linear portion.

### Evaluation Method

The IC tags 1 of Example 1 were evaluated as follows. The IC tags of Examples 2 to 4 and Comparative 1 were likewise evaluated.

(1) The operation of the IC tags 1 of Example 1 were checked through a read/write test (tester: manufactured by FEIG ELECTRONIC GmbH, product name: ID ISC. MR101-USB). The IC tags were also visually examined for a jumper breakage with a microscope.

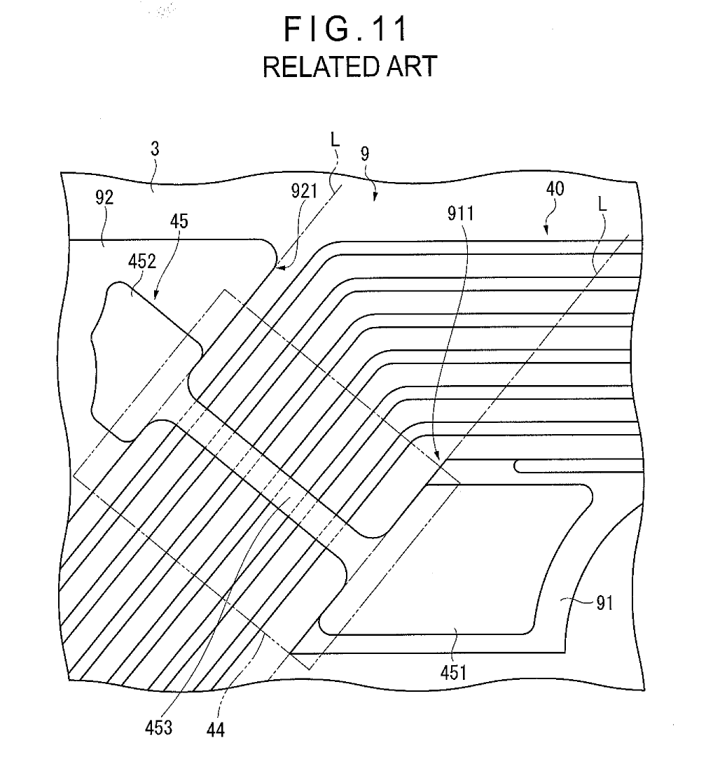

(2) When passing the read/write test and the visual examination, the 20 IC tags 1 of Example 1 were stuck side by side on a PET (Polyethylene Terephthalate) film 71 with a width of 75 mm and a thickness of 25 μm, thereby providing a testing elongated sheet. The IC tags 1 were arranged side by side in a long-side direction of the PET film 71. The IC tags 1 were stuck in such a manner that an extending direction of the side edges 411, 421 coincided with a short-side direction of the PET film 71 and the first surface of the circuit substrate 3 on which the antenna circuit 4 was provided was opposed to the PET film 71. As shown in FIG. 10, the testing elongated sheet was hung on a surface of a columnar roller 72 with a diameter of 20 mm and a weight 73 (load: 7.5 N) was hung from one end of the testing elongated sheet. The other end of the testing elongated sheet was held with hand and repeatedly pulled down and up for a bending test.

Since the IC tags 1 were stuck as described above, the columnar roller 72 made each of the IC tags 1 bent into a valley-like shape around the bending line L, which substantially coincided with the side edges 411, 421, during the bending test. The IC tags of Examples 2 to 4 and Comparative 1 were likewise bent into a valley-like shape around the bending lines L that substantially coincided with the side edges 611, 621, 631, 641, 651, 661, 911, 921.

The bending test was considered to be done once as the testing elongated sheet was pulled up and down once. The read/write test and the visual examination were carried out for each time when the bending test was repeated for 50 times, 75 times and 100 times.

Table 1 shows the evaluation results. When the IC tag did not work properly during the read/write test because of breakage of the jumper 45, the IC tag was considered as a defective.

TABLE 1

| | Percent Defective (%)/Number of Defectives | | | |
|---|---|---|---|---|
| | Before | | | |
| | Bending Test | 50 Times | 75 Times | 100 Times |
| Example 1 | 0/0 | 0/0 | 0/0 | 0/0 |
| Example 2 | 0/0 | 0/0 | 0/0 | 0/0 |
| Example 3 | 0/0 | 0/0 | 0/0 | 0/0 |
| Example 4 | 0/0 | 0/0 | 0/0 | 0/0 |
| Comparative 1 | 0/0 | 20/4 | 80/16 | 80/16 |

As shown in Table 1, the percent defective of each of Examples 1 to 4 in which the side edges 411, 421, 611, 621, 631, 641, 651, 661 were provided with the non-linear portions 412, 422, 612, 622, 632, 642, 652, 662 was 0% even when the bending test was done for 100 times. In contrast, the percent defective of Comparative 1 in which the side edges 911, 921 were not provided with a non-linear portion increased with the increased number of the test and became approximately 80% when the test was done for 75 times. When the defective was observed with 40 magnification with a stereomicroscope equipped with a fluorescent lamp, breakage of the side edge of the jumper was seen. In view of the above, it has been understood that breakage of the jumper can be inhibited by forming the non-linear portion, which is in a non-linear shape in a plan view of the circuit substrate, in the side edge of each of the first and second terminals at a position overlapping with the jumper.

### EXPLANATION OF CODES

2 IC inlet
3 circuit substrate
4 antenna circuit
5 IC chip
40 circuit pattern
41 first terminal
42 second terminal
45 jumper (electrically-conductive member)
412,422 non-linear portion
413,423 bent portion

1. An electrode member comprising:
a circuit substrate; and
a first terminal and a second terminal being provided on at least one surface of the circuit substrate and being not electrically conductive with each other, the first terminal and the second terminal being brought into electrical conduction through an electrically-conductive member, wherein
at least one of the first terminal and the second terminal is provided with a non-linear portion formed in a periphery thereof at a position overlapping with the electrically-conductive member, the non-linear portion being in a non-linear shape in a plan view of the circuit substrate.

2. The electrode member according to claim 1, wherein the non-linear portion comprises at least one of a bent portion being bent at an acute angle or an obtuse angle, a bent portion in a corrugated shape, and a bent portion in a substantially square C-shape.

3. An antenna circuit comprising:
the electrode member according to claim 1;
a coiled circuit pattern being provided on the one surface of the circuit substrate on which the first terminal and the second terminal are provided; and
an electrically-conductive member through which the first terminal and the second terminal are brought into electrical conduction.

4. An IC inlet comprising:
the antenna circuit according to claim 3; and
an IC chip, wherein
the electrode member, the circuit pattern and the electrically-conductive member are brought into electrical conduction through the IC chip to form a loop.
